(19) United States
(12) Patent Application Publication
(10) Pub. No.: US 2010/0286850 A1
(43) Pub. Date: Nov. 11, 2010

(54) Standby Instrument for Aircraft

(75) Inventors: Lionel Collot, Vendome (FR); Henri LeBlond, Versailles (FR); Jerome Papineau, La Chapelle Encherie (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/669,518

(22) PCT Filed: Jul. 15, 2008
(86) PCT No.: PCT/EP08/59240

§ 371 Date: Jul. 17, 2010

(30) Foreign Application Priority Data
Jul. 17, 2007 (FR) 07 05156

(51) Int. Cl. G01C 23/00

(52) U.S. Cl. 701/7

(57) ABSTRACT

The invention relates to a standby instrument for the piloting of aircraft allowing a pilot to restore a display similar to that of a head-up display in the event that the latter should fail. According to the invention, the standby instrument comprises means for determining and displaying a speed vector (11) of the aircraft only with the aid of means usually present in a standby instrument, namely means for measuring static and total pressures of the airstream surrounding the aircraft and means for inertial measurement.

The invention relates to a standby instrument for the piloting of aircraft. Many airplanes, notably military airplanes, have a display system called head-up display showing the pilot much information originating from the primary systems of the aircraft. This information is presented in the form of symbols displayed as an overprint of the landscape visible through glass walls of the aircraft cockpit.

If this display system should fail, the pilot must use standby instrumentation to complete his mission or return to his base. The pilot then uses either the electromechanical instrumentation conventionally present on the instrument panel of the aircraft and comprising an altimeter, an anemometer and an artificial gyroscopic horizon, or a combined standby instrument combining the electromechanical instruments mentioned above.

In both cases, the standby instrumentation displays the information available in ways different from those displayed with a head-up system. The pilot loses the guideline concept in which he was operating. Moreover, certain information, such as the representation of the speed vector of the aircraft, no longer exists, which forces the pilot to change his way of integrating the available parameters in order to pilot his aircraft correctly. This may be all the more tricky because, in a flight phase that has become critical, the loss of the main display system is very often associated with a major failure of the aircraft and therefore additional stress for the pilot.

In a head-up display system, the representation of the speed vector is determined based on information originating from incidence and side-slip probes. The speed vector is notably defined by its direction on three axes, one vertical axis and two horizontal axes. These probes are not usually connected to the standby instrument which prevents determination of the speed vector by the standby instrument.

The object of the invention is to remedy some or all of the problems cited above by proposing a standby instrument that allows the pilot to keep a display similar to a head-up display.

Accordingly, the subject of the invention is a standby instrument for an aircraft comprising means for measuring the static pressure, the total pressure of an airstream surrounding the aircraft, inertia measurement means, means for computing and displaying the altitude, the speed and the attitude of the aircraft, characterized in that it also comprises means for computing and displaying a speed vector of the aircraft.

Advantageously, the means for computing the speed vector compute this vector based on data originating from the means for measuring the static pressure, the total pressure and for inertial measurement. The speed vector is computed without using measurement of the aerodynamic side-slip and incidence of the aircraft. Probes for measuring incidence and side-slip exist on the skin of the aircraft and are used by the primary system of the aircraft. The invention makes it possible to compute and display the speed vector of the aircraft even if the incidence and/or side-slip probes have failed or are unavailable.

In other words, the standby instrument comprises means for determining and displaying a speed vector of the aircraft only with the aid of means usually present in a standby instrument, namely means for measuring static and total pressures of the airstream surrounding the aircraft and means of inertial measurement.

The invention will be better understood and other advantages will appear on reading the detailed description of an embodiment given as an example, a description illustrated by the attached drawing in which:

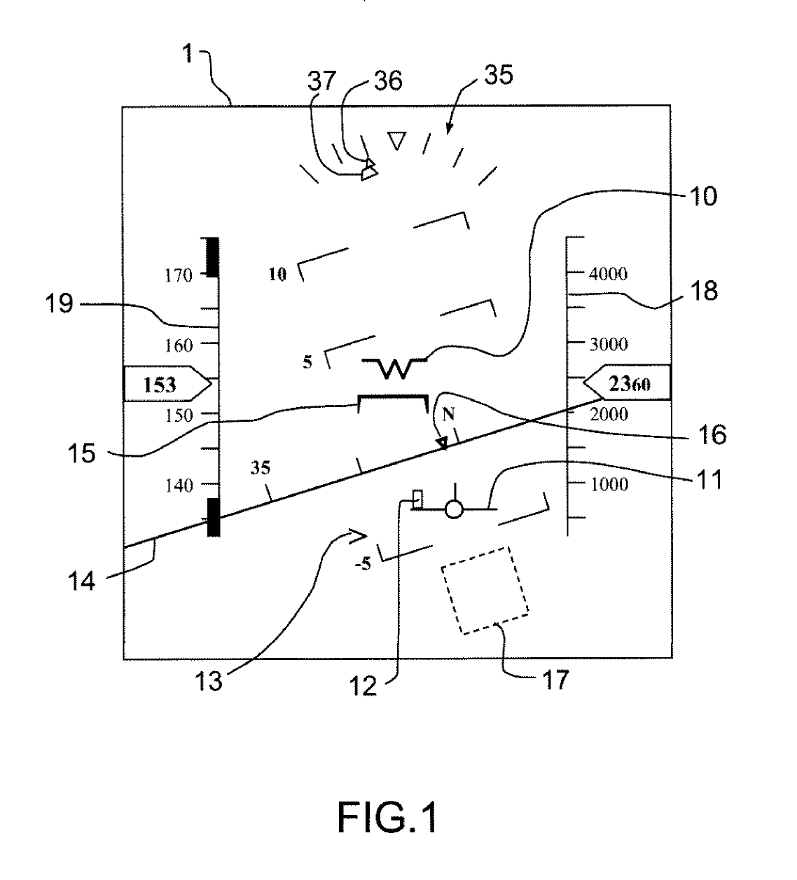

FIG. 1 represents an example of display on a screen of a standby instrument according to the invention;

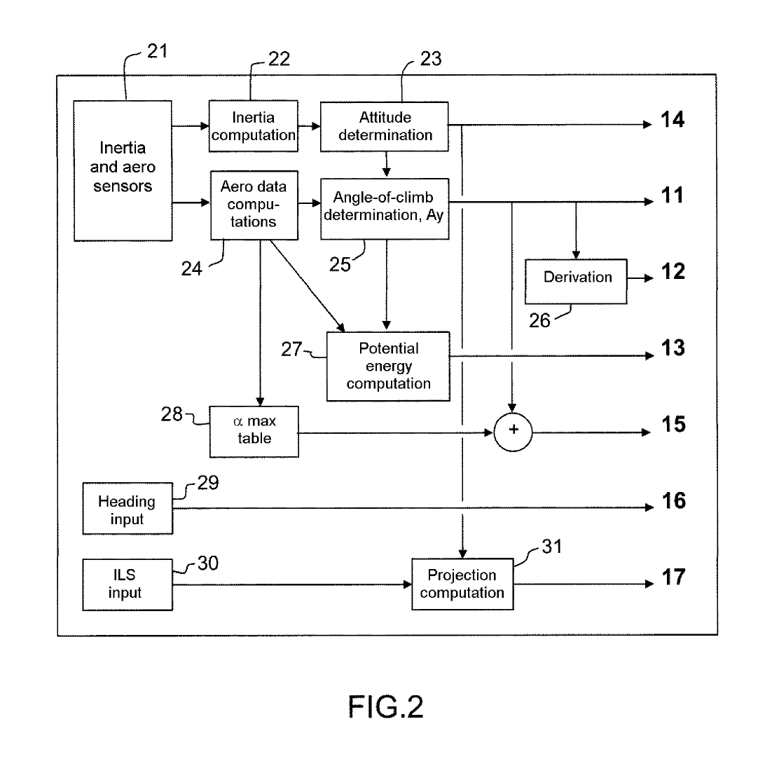

FIG. 2 represents in block diagram form the means for determining various symbols displayed on the screen represented in FIG. 1.

For the purposes of clarity, the same elements will bear the same reference numbers in the various figures.

A standby instrument fitted to the instrument panel of an aircraft comprises means for computing and displaying flight information based on data supplied by the sensors belonging mainly to the standby instrument.

The standby instrument comprises means for measuring the static pressure and the total pressure of an airstream surrounding the aircraft. The means for measuring pressure are connected to pressure heads situated on the skin of the aircraft. The standby instrument comprises no means for measuring the incidence or the aerodynamic side-slip. The standby instrument also comprises means of inertial measurement making it possible to measure the acceleration of the aircraft on three axes of the aircraft, longitudinal, lateral and vertical. The longitudinal acceleration is marked Ax, the lateral acceleration is marked Ay and the vertical acceleration is marked Az.

The standby instrument is used notably in the event of failure of the primary display screens fitted to the instrument panel of an aircraft. The standby instrument comprises computing means and a screen, for example a liquid crystal screen. In a known manner, the instrument displays on its screen the altitude of the aircraft on the right portion of the screen, the speed of the aircraft on the left portion of the screen and the attitude of the aircraft in the center of the screen. The attitude of the aircraft is symbolized by its wings relative to a movable horizon line.

In a head-up display system, the pilot of the aircraft has, as in a known standby instrument, information on speed, altitude and attitude of the aircraft. He also has a display of the speed vector of the aircraft, a vector that is not displayed on the screen of a known standby instrument. In a head-up display system, the speed vector is computed notably based on information received from incidence probes mounted on the skin of the aircraft. These probes belong to the primary system of the aircraft and are not usually made redundant for the standby instrument. The invention allows the pilot to recover the same information as that present in a head-up system, notably the display of the speed vector of the aircraft, despite the absence of certain sensors such as for example the incidence probes.

FIG. 1 represents an example of display on a screen 1 of a standby instrument of the information usually present in a head-up system. Appearing on this screen is a reference symbol 10 representing the axis of the aircraft and situated in the center of the display. The reference symbol 10 is immobile on the screen 1.

A speed vector 11 of the aircraft, called the groundspeed vector or “flight path” in the literature, is symbolized in the form of another reference symbol that can change on the screen depending on the direction of the speed vector 11 of the aircraft relative to the ground. The position of the reference symbol representing the speed vector 11 represents the direction of the speed vector 11 in a plane perpendicular to a longitudinal axis of the aircraft.

Advantageously, the means for computing the speed vector 11 compute this vector based on data originating from means for measuring the static pressure, the total pressure and for measuring inertia without using measurement of the aerodynamic side-slip and incidence of the aircraft. More precisely, based on the difference in measurement between the total pressure Pt and the static pressure Ps, the CAS modulus of the conventional speed vector of the aircraft, well known in the literature under the name “Conventional Air Speed” is defined. The total pressure Pt and the static pressure Ps are given by the pressure sensors connected respectively to a total pressure head and to a static pressure head both situated on the skin of the aircraft. A groundspeed TAS of the aircraft, well known in the literature under the name of “True Air Speed”, is obtained based on the conventional speed CAS and the static temperature of the air surrounding the aircraft. The static temperature necessary for estimating the groundspeed relative to the airspeed may be estimated by assuming an atmosphere called standard. In other words, a linear change of the static temperature as a function of the altitude is assumed.

With the static pressure measurement Ps making it possible to determine a barometric altitude, also called pressure altitude, an estimate of the airspeed on trajectory is computed based on these various elements. The groundspeed TAS is then obtained by projection on the horizontal plane of the previously estimated airspeed.

Advantageously, the means for computing the speed vector 11 compute the direction of the speed vector 11 based on inertia measurement means notably based on the determination of the roll and pitch of the aircraft. More precisely, the inertia measurement means comprise for example accelerometers measuring three accelerations, Ax, Ay and Az in a guideline linked to the aircraft, and gyrometers measuring three angular speeds Gx, Gy and Gz of the aircraft around the three guideline axes linked to the aircraft.

Advantageously, the vertical speed Vz is determined by a double estimate, on the one hand the drift of the pressure altitude and on the other hand the integration of the inertial acceleration Az reduced by the acceleration of gravity. Advantageously, this double estimate is made through a conventional measurement technique called a baro-inertial loop.

An angle of climb P of the aircraft may then be defined by the relation:

P=arc sin(Vz/TAS) (1)

In conventional manner, the speed vector 11 is represented in FIG. 1 by an ergonomic symbol, the position of which on the plane of FIG. 1 is determined on the one hand by the angle of climb P, with respect to its position in the vertical plane, and, on the other hand, by the lateral acceleration Ay with respect to its position in the horizontal plane. Advantageously, the standby instrument comprises means for computing and displaying a predictive speed vector 12 of the aircraft. The predictive speed or trend vector 12 is computed based on the change (or drift) in the position of the symbol 11. The trend 12 indicates the direction in which the trajectory of the aircraft is changing. The trend position 12 on the screen 1 shows, for example, a future position, at the end of a certain time, of the speed vector 11.

The standby instrument also comprises means for computing and displaying a potential energy W of the aircraft based on the angle of climb P of the aircraft and on the speed vector 11. More precisely, the potential energy W is defined by:

$$W = sin ( P ) + \frac{1}{g} \frac{d ( TAS )}{d t} \qquad ( 2 )$$

In this formula, g represents the acceleration of gravity.

A hook 13 represents the value of potential energy or total angle of climb of the aircraft. This value corresponds to the angle of climb that the aircraft may take with the current thrust, while maintaining its speed. When the hook 13 is aligned with the symbol representing the speed vector 11, the speed of the aircraft is constant.

Advantageously, the instrument comprises means for computing and displaying a horizon line 14 corresponding to that usually displayed on a standby instrument and inclined according to the attitude of the aircraft. To determine the attitude of the aircraft, it is possible, for example, to refer to French patent application FR 2 614 694 filed in the name of SFENA. The horizon line 14 is displayed in the form of a line separating 2 half-planes of colors which may if necessary be different in order to distinguish them rapidly. The sky is, for example, shown in blue or gray and the ground in brown or black. Moreover, it is possible to display an arc of a circle, not shown in FIG. 1, in the center of the horizon line 14, situated on the sky side, and making it possible to rapidly identify whether the aircraft is in a ventral or dorsal position. The horizon line 14 provides the attitude of the airplane, by difference with the symbol 10. The difference between the horizon line 14 and the speed vector 11 is linked to the incidence and to the side-slip of the aircraft.

The standby instrument advantageously comprises means for computing and displaying a limit value of incidence. More precisely, displayed on the screen 1 is a limit incidence hook 15 allowing the pilot to ascertain the maximal incidence that the aircraft cannot exceed without risk of stalling. The value of this maximal incidence may be a value that is fixed or a function of the conventional speed of the aircraft.

The horizon line 14 is graduated in heading. In FIG. 1, there appear two graduation values: 35 for a 350° heading and N for north. A heading followed by the aircraft is displayed in the form of a tab mark 16 that can be moved along the horizon line 14.

Advantageously, the standby instrument comprises means for computing and displaying an approach box 17 representing a desirable approach trajectory in a landing phase of the aircraft. This trajectory is, for example, defined with the aid of a landing-aid system, well known in the literature under the name of ILS for “Instrument Landing System”. The approach box 17 also informs the pilot of the regulatory angular tolerances in the vertical and horizontal around the desirable trajectory. In an approach phase, the pilot must place the symbol representing the speed vector 11 in the approach box 17 in order to place the aircraft on the correct approach trajectory. While the symbol is outside the approach box, the outline of the approach box 17 is drawn in dashed lines and once the symbol is positioned in the box 17, the dashed line is converted into a solid line.

The information necessary for displaying the heading tab mark 16 and the approach box 17 is received by the standby instrument from primary systems of the aircraft on inputs, usually digital inputs, of the standby instrument.

A first graduated scale 18, representing the altitude of the aircraft, is displayed in the right portion of the screen 1 and a second graduated scale 19, representing the speed of the aircraft, is displayed in the left portion of the screen 1. The speed of the aircraft, displayed on the scale 19, represents the modulus of the speed vector relative to the air, while the speed vector 11 represented by its symbol represents the direction or trajectory of the aircraft relative to the ground.

Advantageously, the standby instrument comprises means for determining a roll and a side-slip of the aircraft. These two items of information are displayed in the top portion of the screen 1 in a guide 35 graduated angularly for example every 5°. A first tab mark, in the form of a triangle 36, makes it possible to display the roll of the aircraft. The roll is determined by integration of the angular speed Gx of the aircraft around its longitudinal axis. A second tab mark in the form of a parallelogram 37 makes it possible to display the side-slip of the aircraft determined from the lateral acceleration Ay of the aircraft. The side-slip is displayed in the form of an offset between the parallelogram 37 and the triangle 36.

FIG. 2 represents in block diagram form various means for determining the various symbols displayed on the screen 1. In a box 21 are placed the inertia measurement means and the means for measuring the static pressure Ps and the total pressure Pt of an airstream surrounding the aircraft. The inertia measurement means, by a computation of inertia, carried out in box 22, make it possible to determine in box 23 the attitude of the aircraft in order to display the horizon line 14. Moreover, the means for measuring the pressure make it possible in box 24 to define notably the conventional speed CAS and the estimate of the groundspeed TAS of the aircraft. The speed vector 11 is determined in box 25 by using the attitude data and the anemo-barometric data computed in box 24. The trend 12 is defined by derivation, in box 26, of the change in the speed vector 11.

The angle of climb P computed in box 26 and the estimated TAS value in box 24 make it possible to compute the potential energy W in box 27. A table 28 of limit incidence associated with the modulus of the speed vector 11 makes it possible to define the limit incidence hook 15.

Advantageously, the standby instrument comprises means for computing and displaying an approach box 17 defining a guideline of the trajectory of the aircraft during landing. More precisely, an input of the standby instrument receiving information on the heading followed by the aircraft is represented in box 29, which makes it possible to define the display of the heading tab mark 16. Another input originating from the ILS and shown in box 30 makes it possible to define the approach box 17. The ILS is a radio system giving information on the axis of a runway where the aircraft can land. The center of this approach box 17 is given directly by the information originating from the ILS. This information is well known in the literature under the name of GLIDE for a vertical angular position, and LOC for a horizontal angular position. The size of the box is constant, because of the angular representation, and is defined by the user-friendliness of the screen 1.

1. A standby instrument for an aircraft comprising means for measuring the static pressure, the total pressure of an airstream surrounding the aircraft, inertia measurement means, means for computing and displaying the altitude, the speed and the attitude of the aircraft, and means for computing and displaying a speed vector of the aircraft, with respect to its vertical and lateral components in a guideline linked to the aircraft, based on data originating from the means for measuring the static pressure, the total pressure and for inertial measurement.

2. The standby instrument as claimed in claim 1, wherein the means for computing the speed vector compute this vector without using measurement of the aerodynamic side-slip and incidence of the aircraft.

3. The standby instrument as claimed in claim 1, wherein the means for computing the speed vector compute a modulus of the airspeed vector of the aircraft based on the difference in measurement between the total pressure and the static pressure, correct the modulus of the airspeed vector according to the altitude of the aircraft determined by means of the measurement of the static pressure and of a measurement of air temperature surrounding the aircraft in order to obtain the modulus of the groundspeed vector.

4. The standby instrument as claimed in claim 1, wherein the means for computing the speed vector compute the direction of the speed vector of the aircraft with the aid of inertia measurement means.

5. The standby instrument as claimed in claim 1, further comprising means for computing and displaying a predictive speed vector of the aircraft.

6. The standby instrument as claimed in claim 1, further comprising means for computing and displaying a potential energy of the aircraft based on an angle of climb of the aircraft and on the speed vector.

7. The standby instrument as claimed in claim 1, further comprising means for computing and displaying a limit value of incidence.

8. The standby instrument as claimed in claim 1, further comprising means for computing and displaying a horizon line inclined according to the attitude of the aircraft wherein a heading followed by the aircraft is displayed on the horizon line.

9. The standby instrument as claimed in claim 1, further comprising means for computing and displaying an approach box defining a guideline of the trajectory of the aircraft during landing.
